(19) United States
(12) Patent Application Publication
(10) Pub. No.: US 2026/0140474 A1
(43) Pub. Date: May 21, 2026

(54) COUPLING, ROTATING MEMBER, AND PROCESS CARTRIDGE

(71) Applicant: ZHUHAI UN-TERN IMAGING PRODUCTS CO., LTD., Zhuhai (CN)

(72) Inventor: Wugang TAN, Zhuhai (CN)

(21) Appl. No.: 19/217,021

(22) Filed: May 23, 2025

Related U.S. Application Data
(63) Continuation of application No. 19/181,727, filed on Apr. 17, 2025, now abandoned.
Application No. 19/181,727 is a continuation of application No. PCT/CN2023/125268, filed on Oct. 18, 2023.

(30) Foreign Application Priority Data
Oct. 18, 2022 (CN) 202222744712.7
Jul. 26, 2023 (CN) 202321988819.4

(51) Int. Cl. G03G 21/18

(52) U.S. Cl. CPC G03G 21/186

(57) ABSTRACT

A coupling is used for receiving a driving force from a force output member arranged in an imaging device to drive a rotating body to rotate, the force output member comprising a braking force output member and a driving force output member which are coaxially arranged. The coupling includes driving force receiving members and a pushing element. The driving force receiving members are used for being combined with the driving force output member so as to receive the driving force for driving the rotating body to rotate. The pushing element is used for abutting against the braking force output member. When viewed in a direction perpendicular to the axis of rotation of the coupling, the driving force receiving members are further away from the rotating body than the pushing element.

### CROSS-REFERENCE TO RELATED APPLICATIONS

This application is a continuation of U.S. application Ser. No. 19/181,727, filed on Apr. 17, 2025, which is a continuation application of PCT Patent Application No. PCT/CN 2023/125268, filed on Oct. 18, 2023, which claims priority to Chinese patent application No. 202222744712.7, filed on Oct. 18, 2022, and Chinese patent application No. 202321988819.4, filed on Jul. 26, 2023, the disclosures of which are incorporated herein by reference in their entireties.

### TECHNICAL FIELD

The present disclosure relates to technical field of electrophotographic imaging, and in particular, to a process cartridge detachably mounted in an electrophotographic imaging device, and a rotatable member and a coupling that are located in the process cartridge.

### BACKGROUND

Generally, a process cartridge detachably mounted in an electrophotographic imaging device (imaging device for short) is required to be provide with at least one rotatable body which may rotate around a rotational axis. When the process cartridge is working, the rotatable body is used for stirring developer in the process cartridge, or providing the developer to other components, or forming an electro-static latent image on its surface and receiving developer to develop the electro-static latent image, etc. For this purpose, a coupling which may constantly receive driving force from the imaging device is required to be disposed in the process cartridge. When the coupling receives the driving force, the rotatable body can be driven.

The Chinese patent application No. CN113574469A discloses an imaging device, the imaging device is provided with a force output member including both a driving force output member and a braking force output member. When the rotatable body is required to work, the driving force output member is used for outputting a driving force to the coupling. When the rotatable body is required to stop working, the braking force output member is used for outputting a braking force to the coupling to prevent the rotatable body from continuous rotating due to inertance.

Corresponding to the force output member, the coupling is required to be provided with a guide part to engage the coupling with the force output member. Both the braking force output member and a component in the coupling used for receiving the braking force, are configured in a barbed shape. This results in that the configuration of the coupling is complicated, thereby increasing its manufacturing accuracy requirements. In addition, in a process of engaging the coupling with the force output member, the braking force output member in a barbed shape is easily damaged.

### SUMMARY

According to various embodiments of the present disclosure, the present disclosure provides a coupling with a simple structure.

A coupling, configured to receive a driving force from a force output member disposed in an imaging device to drive a rotatable body to rotate. The force output member includes a braking force output member and a driving force output member that are arranged coaxially. The coupling includes a driving force receiver and a pushing element. The driving force receiver is configured to be engaged with the driving force output member to receive the driving force to drive the rotatable body to rotate. The pushing element is configured to abut against the braking force output member. When viewed in a direction perpendicular to a rotational axis of the coupling, the driving force receiver is farther away from the rotatable body than the pushing element. The coupling does not need to be provided with a component for receiving a braking force, the structure of the coupling is thus able to be simplified and the manufacturing accuracy requirements thereof are reduced, and a risk of damage to the braking force output member in the force output member is reduced.

The present disclosure further provides a rotatable member including a rotatable body and the aforementioned coupling. The coupling and the rotatable body are arranged coaxially.

The present disclosure further provides a process cartridge including a housing and the rotatable member. The rotatable member rotatably disposed in the housing.

The present disclosure further provides another process cartridge, which includes a housing, a rotatable body rotatably mounted in the housing, the coupling as described above, and a driving force transmission device provided between the coupling and the rotatable body. The coupling and the rotatable body are not coaxial. A driving force from the coupling is transmitted to the rotatable body through the driving force transmission device.

### BRIEF DESCRIPTION OF THE DRAWINGS

FIG. 1 is a perspective view of a process cartridge according to the present disclosure.

FIG. 2A is a perspective view of a force output member of an imaging device to which a process cartridge is applicable according to the present disclosure.

FIG. 2B is an exploded schematic view of some of components of the force output member.

FIG. 2cis a sectional view of a force output member taken along a plane passing through a rotational axis of the force output member.

FIG. 2D is a side view of a force output member, viewed in a direction of the rotational axis of the force output member.

FIG. 3A is a perspective view of a coupling according to Embodiment 1 of the present disclosure.

FIG. 3B is an exploded schematic view of the coupling according to Embodiment 1 of the present disclosure.

FIG. 3C is a sectional view of the coupling taken along a plane passing through a rotational axis of the coupling according to Embodiment 1 of the present disclosure.

FIG. 4A to FIG. 4D are schematic views showing a process of the coupling being engaged with a force output member according to Embodiment 1 of the present disclosure.

FIG. 5B to FIG. 5D are enlarged partial views respectively corresponding to the coupling and the force output member shown in FIG. 4B to FIG. 4D.

FIG. 6 is a schematic view of relative position of the coupling and the force output member according to Embodiment 1 of the present disclosure after the coupling is engaged with the force output member.

FIG. 7 is a perspective view of a coupling according to Embodiment 2 of the present disclosure.

FIG. 8A and FIG. 8B are schematic views showing a process of the coupling being engaged with a force output member according to Embodiment 2 of the present disclosure.

FIG. 9 is a perspective view of a coupling according to Embodiment 3 of the present disclosure.

FIG. 10 is a partial perspective view of the coupling according to Embodiment 3 of the present disclosure with a portion thereof removed.

FIG. 11A is a side view of the coupling according to Embodiment 3 of the present disclosure, viewed in a direction perpendicular to a rotational axis thereof.

FIG. 11B is a side view of the coupling according to Embodiment 3 of the present disclosure, viewed in a direction of the rotational axis thereof.

FIG. 12A to FIG. 12care schematic views showing a process of the coupling being engaged with a force output member according to Embodiment 3 of the present disclosure.

### DETAILED DESCRIPTION

Embodiments of the present disclosure are described in detail below in conjunction with the drawings.

### Process Cartridge

FIG. 1 is a perspective view of a process cartridge according to the present disclosure.

The process cartridge 100 includes a housing 1 and a rotatable body 11 rotatably mounted in the housing 1. The rotatable body 11 may rotate around a rotational axis L11 extending in a x direction after receiving a driving force. An end of the rotatable body 11/process cartridge 100 in a +x direction is configured to receive the driving force. For this reason, the end of the process cartridge 100 in the +x direction is referred to as a driving end, and another end of the process cartridge 100 opposite to the driving end is referred to as a non-driving end.

The process cartridge 100 may be disposed in an imaging device. Different types of imaging devices have different configurations. According to the configuration of the imaging device, the process cartridge 100 may be configured to be detachably mounted to the imaging device along the x direction or a direction intersecting with the x direction. According to the configuration of the process cartridge 100, the process cartridge 100 may be configured as a developer accommodating unit 100a configured for accommodating only developer, a developing unit 100b capable of carrying the developer, an imaging unit 100c capable of forming an electrostatic latent image, or a combination of at least two of the developer accommodating unit 100a, the developing unit 100b, or the imaging unit 100c. A stirring member capable of stirring the developer is rotatably disposed in the developer accommodating unit 100a. The stirring member may be considered as a kind of rotatable body. A developing member is rotatably disposed in the developing unit 100b. The developing member is configured to carry the developer and convey the developer towards the imaging unit 100c. In addition, a supplying member is also rotatably disposed in the developing unit 100b. The supplying member is configured to supply the developer towards the developing member. The developing member or supplying member may be considered as a kind of the rotatable body as well. A photosensitive member is rotatably disposed in the imaging unit 100c. The photosensitive member is configured to form an electrostatic latent image on its surface and receive the developer supplied by the developing member, so as to develop the electrostatic latent image. The photosensitive member may also be considered as a kind of rotatable body.

A coupling 2 as described below may be directly provided on an end of the rotatable body 11. Meanwhile, the coupling 2 and the rotatable body 11 are coaxial and the two both constitute part of a rotatable member. When the coupling 2 receives a driving force, the rotatable body 11 may be directly driven. The coupling 2 may also be provided at a position that is not coaxial with the rotatable body 11. When the coupling 2 receives the driving force, the coupling 2 conveys the driving force to the rotatable body 11 through a driving force transmission device. Therefore, a rotational axis L2 of the coupling 2 is coaxial with or parallel to the rotational axis L11 of the rotatable body 11.

In view of the above-mentioned multiple options for the rotating body 11, the position of the coupling 2 can also be selected in multiple ways. Meanwhile, in order to clearly show a process of engaging the coupling 2 with a force output member of the imaging device, the rotatable body 11 will not be shown hereinafter. However, it can be understood that, the rotatable body 11 receives the driving force from the coupling 2 and rotates.

### Force Output Member

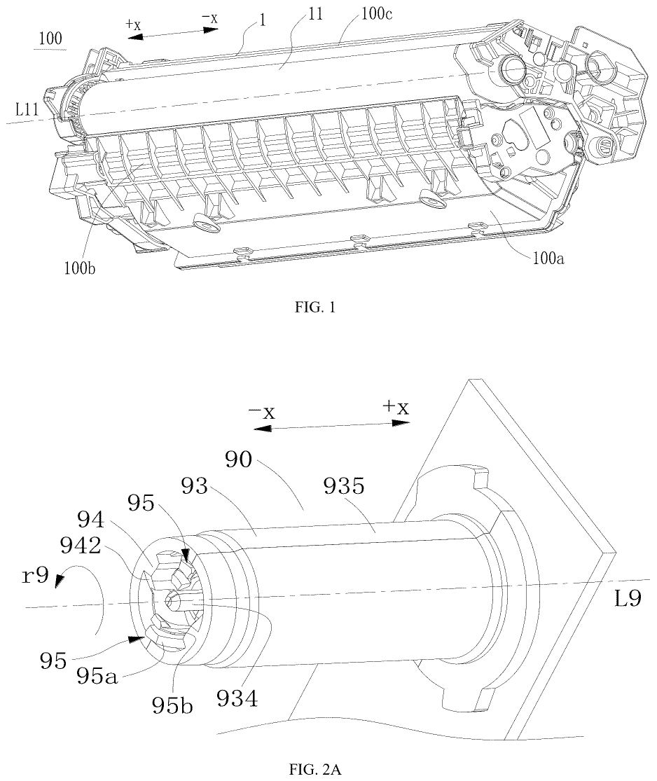

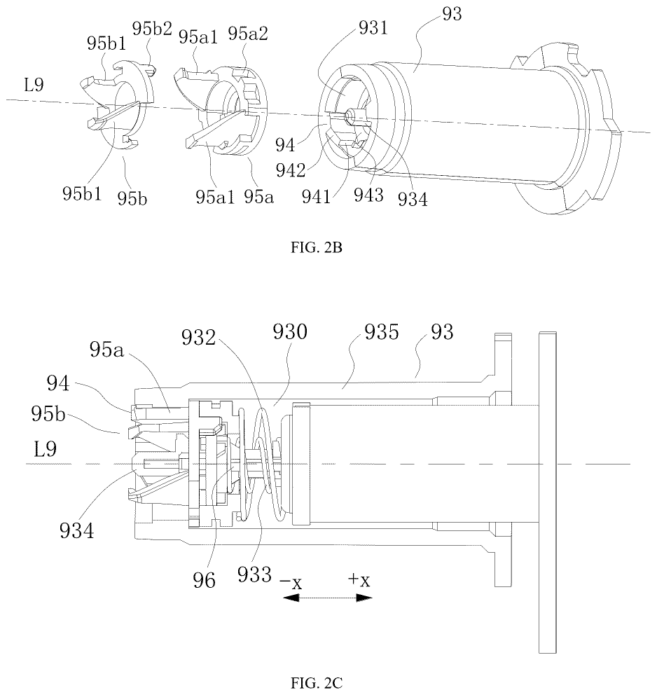

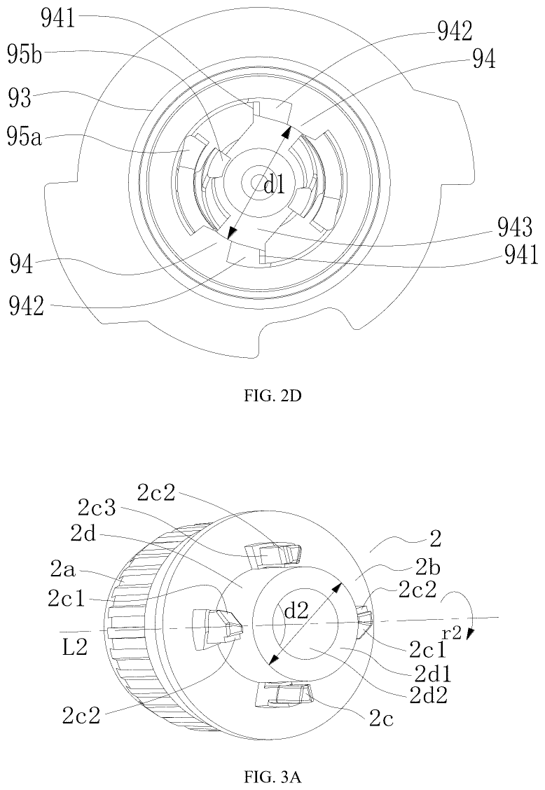

FIG. 2A is a perspective view of a force output member of an imaging device to which the process cartridge is applicable according to the present disclosure. FIG. 2B is an exploded schematic view of some of components of the force output member. FIG. 2cis a sectional view of the force output member taken along a plane passing through the rotational axis of the force output member. FIG. 2D is a side view of the force output member, viewed in a direction of the rotational axis of the force output member.

The imaging device to which the process cartridge of the present disclosure is applicable may incudes a force output member 90. In order for decreasing interference of the force output member with the process cartridge in a process of mounting or dismounting the process cartridge, there is a solution that the force output member is disposed to be telescopically movable along the x direction. For example, the force output member is disposed to be linked with a cover of the imaging device. When the cover is opened, the force output member retracts along the +x direction. When the cover is closed, the force output member extends out along the-x direction.

As shown in FIGS. 2A and 2D, the force output member 90 may rotate, around a rotational axis L9 parallel to the x direction, in a direction indicated by r9. The force output member 90 includes: a sleeve 93; a braking force output member 95 disposed in the sleeve 93; and a first elastic pushing member 932 and a second elastic pushing member 933 that are both disposed in the sleeve 93. The sleeve 93 includes a sleeve body 935 having a sleeve cavity 930. The braking force output member 95, the first elastic pushing member 932 and the second elastic pushing member 933 are all disposed in the sleeve cavity 930. In addition, the sleeve 93 is further provided with a plurality of driving force output members 94 and a connecting member 943 connecting at least two of the driving force output members 94. In an example, the connecting member 943, the plurality of driving force output members 94 and the sleeve body 935 are integrally formed. Along a circumferential direction of the sleeve body 935, an exposure opening 931 is formed between two adjacent driving force output members 94. The braking force output member 95 is exposed via the exposure opening 931. The driving force output member 94 and braking force output members 95 may rotate together around the rotational axis L9. Each of the driving force output members 94 is provided with a driving force output surface 941 and a guide surface 942 that are adjacent to each other. In an example, the driving force output members 94 radially protrude inwardly from an inner wall of the sleeve body 935. Along the radial direction of the sleeve 93, a diameter of a circle formed by inner walls of the driving force output members 94 is denoted as d1.

The first elastic pushing member 932 is configured to apply a pushing force to the sleeve body 935 along the −x direction. The second elastic pushing member 933 is configured to apply a pushing force to the braking force output member 95 along the −x direction. The magnitude of the pushing force applied by the first elastic pushing member 932 to the sleeve body 935 is different from the magnitude of the pushing force applied by the second elastic pushing member 933 to the braking force output member 95. As a result, the braking force output member 95 may move relative to the sleeve body 935 along the x direction.

The braking force output member 95 includes a first braking force output element 95a and a second braking force output element 95b, that are coaxial and may be separable from each other. The first braking force output member 95 is provided with a plurality of first braking force output parts 95a1 and an engaging part 95a2 configured to be engaged with the second braking force output element 95b. The second braking force output element 95b is provided with a plurality of second braking force output parts 95b1 and an engaged part 95b2 configured to be engaged with the first braking force output element 95a. Along the radial direction of the sleeve 93, the first braking force output parts 95a1 are located outside the second braking force output parts 95b1. Namely, the first braking force output parts 95a1 are farther away from the rotational axis L9 than the second braking force output parts 95b1. Along the rotational direction r9, the first braking force output part 95a1 and the driving force output member 94 are basically positioned on a same circumference. The second braking force output parts 95b1 is closer to the rotational axis L9 than the driving force output member 94.

Along the rotational direction r9, the engaging part 95a2 and the engaged part 95b2 are not separable from each other, so that a force is able to be transmitted between the first braking force output element 95a and second braking force output element 95b through engagement between the engaging part 95a2 and engaged part 95b2. When any one of the first braking force output element 95a or the second braking force output element 95b receives a force in the +x direction, the braking force output member 95 as a whole may move along the rotational axis L9 towards the +x direction under the drive of the second braking force output element 95b. Namely, the braking force output member 95 as a whole moves towards an interior of the sleeve cavity 930.

In addition, the force output member 90 further includes an intermediate transmission member 96 disposed in the sleeve cavity 930. The first braking force output element 95a and the intermediate transmission member 96 may also be engaged with or disengaged from each other in the direction of the rotational axis L9, and is not disengaged from each other in the direction of the rotational direction r9. Thus, when the braking force output member 95 as a whole move towards the interior of the sleeve cavity 930, the braking force output member 95 would be disengaged from intermediate transmission member 96. In this case, the braking force output member 95 would be able to freely rotate around the rotational axis L9 in the direction r9, that is, the driving force output member 94 and the braking force output member 95 may rotate relative to each other.

### Coupling

### Embodiment 1

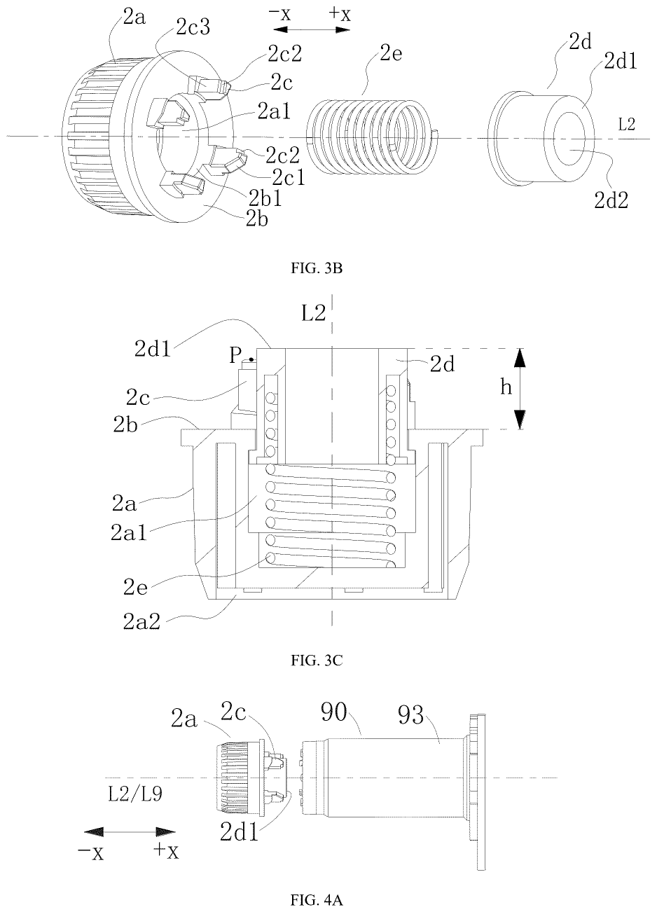

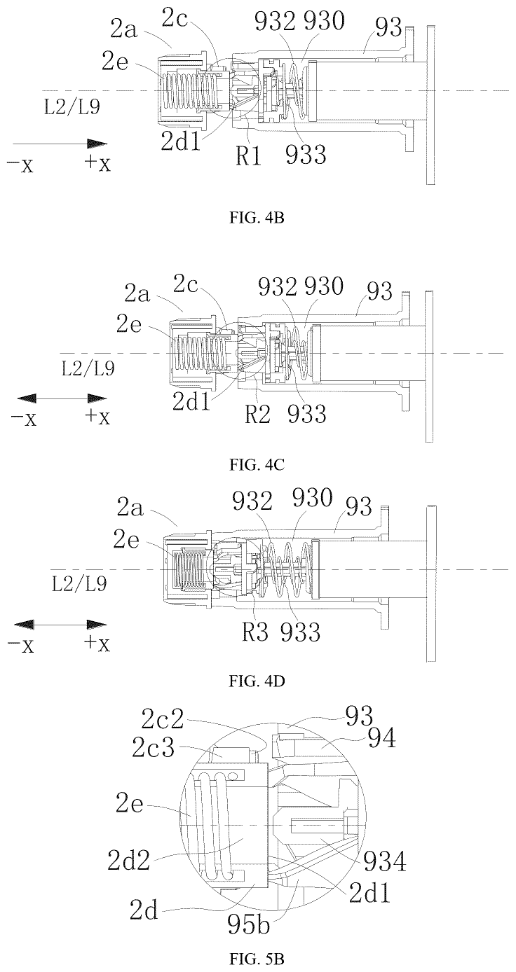

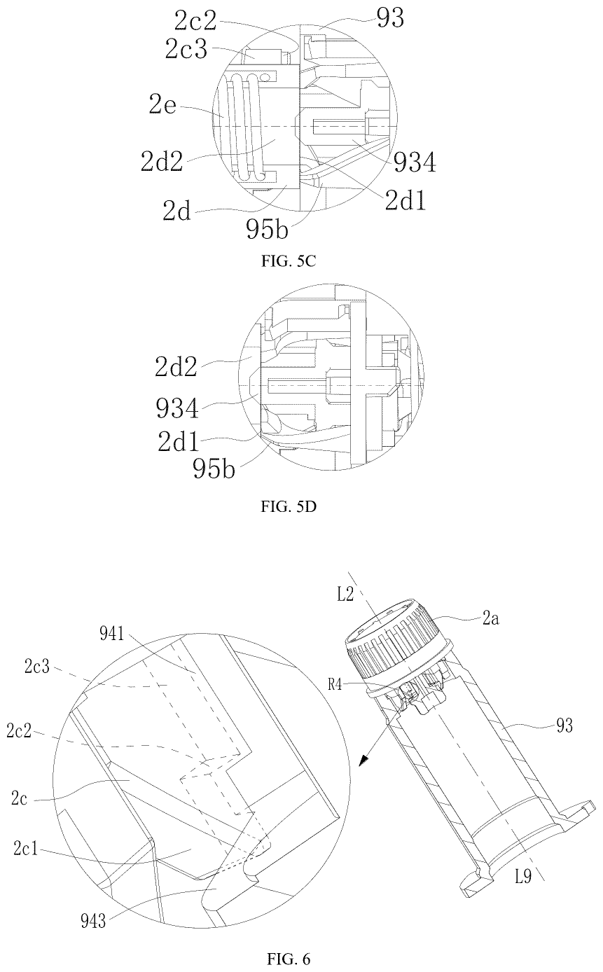

FIG. 3A is a perspective view of a coupling according to Embodiment 1 of the present disclosure. FIG. 3B is an exploded schematic view of the coupling according to Embodiment 1 of the present disclosure. FIG. 3C is a sectional view of the coupling taken along a plane passing through a rotational axis of the coupling according to Embodiment 1 of the present disclosure. FIG. 4A to FIG. 4D are schematic views showing a process of the coupling being engaged with a force output member according to Embodiment 1 of the present disclosure. FIG. 5B to FIG. 5D are enlarged partial views respectively corresponding to the coupling and the force output member in FIG. 4B to FIG. 4D. FIG. 6 is a schematic view of relative position of the coupling and the force output member according to Embodiment 1 of the present disclosure after the coupling is engaged with the force output member.

The coupling 2 may rotate around the rotational axis L2 extending in the x direction, in a rotational direction r2. The coupling 2 includes a base 2a, a base plate 2b, a driving force receiver 2c, and a pushing element 2d. In a process of the coupling 2 being engaged with the force output member 90, the pushing element 2d is configured to push the braking force output member 95 along the rotational axis L9 of the force output member 90. The driving force receiver 2c is configured to be engaged with the driving force output member 94 in the rotational direction r9 of the force output member 90. The base plate 2b is connected to the base 2a. The driving force receiver 2c may be directly disposed on the base 2a, or may disposed on the base plate 2b1. No matter whether the coupling 2 is provided with the base plate 2b, after the driving force receiver 2c receives a driving force, the base 2a is able to transmit out the driving force and drive the rotatable body 11 to rotate. In the radial direction of the coupling 2, the pushing element 2d is located on the inner side of the driving force receiver 2c, that is, the driving force receiver 2c is farther away from the rotational axis L2 than the pushing element 2d. On one hand, such configuration prevents the driving force receiver 2c from interfering with the abutment between the pushing element 2d and the braking force output member 95, on the other hand, the pushing element 2d may be protected by the driving force receiver 2c.

It can be understood that, the base plate 2b may be considered as part of the base 2a to improve the overall structural design freedom of the coupling 2. The following description will be given by taking the configuration with the base plate 2b as an example.

In this embodiment, the pushing element 2d is configured to be movable relative to the base 2a. Specifically, the coupling 2 further includes an elastic element 2e that is engageable with the pushing element 2d. The elastic element 2e is configured to push the pushing element 2d in the +x direction. When the pushing element 2d receives a force in the −x direction, the pushing element 2d moves/retracts in the −x direction relative to the base 2a, and the elastic element 2e undergoes elastic deformation. In contrast, when the force is removed, the elastic element 2e releases an elastic force, and thus the pushing element 2d moves/extends in the +x direction relative to the base 2a. In an example, the elastic element 2e is provide as a compression spring. In an example, the elastic force of the elastic element 2e is greater than that of the second elastic pushing member 933 and small than that of the first elastic pushing member 932.

As shown in FIGS. 3A to 3D, a motion cavity 2a1 is formed inside the base 2a. The motion cavity 2a1 is provide with a bottom plate 2a2 on a side far from the base plate 2b/driving force receiver 2c. An end of the elastic element 2e abuts against the bottom plate 2a2, and another end of the elastic element 2e abuts against the pushing element 2d. As such, the elastic element 2e may be compressed or extended in the motion cavity 2a1. In addition, the base 2a/base plate 2b is provided with an opening 2b1 in communication with the motion cavity 2a1. The elastic 2e and the pushing element 2d are disposed in the motion cavity 2a1 through the opening 2b1.

The shape of the pushing element 2d is not limited, as long as the pushing element 2d is able to abut against the braking force output member 95 and push the braking force output member 95 towards the interior of the sleeve cavity 930. For example, the pushing element 2d is configured to be a regular cylinder or an irregular body. No matter what the shape the pushing element 2d is, the pushing element 2d is provided with a pushing surface 2d1 configured to abut against the braking force output member 95. Before the coupling 2 is engaged with the force output member 90, along the rotational axis L2, a protruding height of the pushing element 2d relative to the base 2a/base plate 2b is in a range of 1 mm to 7 mm. Alternatively, the shortest distance between the pushing surface 2d1 and the base 2a/base plate 2b is in the range of 1 mm to 7 mm. In an example, the pushing surface 2d1 is an end surface of the pushing element 2d. In the radial direction of the coupling 2, at least the maximum dimension d2 of an end of the pushing element 2d in the +x direction is less than d1. Specifically, the value of d2 does not exceed 11 mm. When the pushing element 2d is provided as a cylinder, a cross-sectional diameter of the pushing element 2d does not exceed 11 mm.

The driving force receiver 2 c is formed by protruding from the base 2a/base plate 2b towards the +x direction. In the rotational direction r2, at least one driving force receiver 2c is provided. As shown in FIG. 3A, the driving force receiver 2c is provided with a driving force receiving surface 2c3 configured to receive the driving force. In an example, the driving force receiving surface 2c3 has a shape that is able to match the driving force output surface 941. In addition, the driving force receiver 2c is further provided with an adjustment surface 2c1 capable of guiding the driving force receiver 2c/coupling 2. In an example, the adjustment surface 2c1 is disposed to be inclined relative to the rotational axis L2 of the coupling. In the process of the coupling 2 being engaged with the force output member 90, when the coupling 2 and force output member 90 interfere with each other, the adjustment surface 2c1 is able to adjust the relative position between the coupling 2 and the force output member 90, so that the coupling 2 and the force output member 90 can be smoothly engaged with each other. In an example, the adjustment surface 2c1 is configured as an inclined surface or a spiral surface.

In some embodiments, the driving force receiver 2c may be further provided with an avoiding part 2c2 configured to avoid the force output member 90, thereby ensuring that the coupling 2 and the force output member 90 can be engaged with each other smoothly. In an example, the avoiding part 2c2 is disposed to be adjacent to the driving force receiving surface 2c3. In an example, in the rotational direction r2 of the coupling, the driving force receiving surface 2c3, the avoiding part 2c2, and the adjustment surface 2c1 are provided in sequence. Furthermore, in a direction intersecting with the rotational axis L2, the size of the driving force receiver 2c decreases as the driving force receiver 2c gradually moves away the base 2a/base plate 2b, so that it is thus more conducive to smooth engagement between the driving force receiver 2c and the driving force output member 94.

The following describes the process of engaging the coupling 2 with the force output member 90 in conjunction with FIG. 4, FIG. 5, and FIG. 6. In order to clearly show the relative position between the coupling 2 and force output member 90, FIG. 4B, FIG. 4C and FIG. 4D are sectional views showing the coupling 2 and the force output member 90 taken along the rotational axis L9.

As shown in FIG. 4A, after the coupling 2 reaches a predetermined mounting position of the imaging device along with the process cartridge, the force output member 90 is in a retracted state in which the force output member 90 is not engaged with the coupling 2. As the cover is closed, the force output member 90 begins to move/extend towards the −x direction along the rotational axis L9. As shown in FIG. 4B and FIG. 5B, the pushing surface 2d1 begins to abut against the second braking force output element 95b. In this case, the driving force receiver 2c is not in contact with the driving force output member 94. Thus, for the coupling 2, in an example, before the coupling 2 is engaged with the force output member 90, along the rotational axis L2, the pushing surface 2d1 is farther away from the base 2a/base plate 2b than the driving force receiver 2c/driving force receiving surface 2c3. As shown in FIG. 3C, along the rotational axis L2, the pushing surface 2d1 is higher than a highest point P of the driving force receiver 2c.

As the cover continues to close, as shown in FIG. 4C and FIG. 5C, the second elastic pushing member 933 begins to be compressed, and the second braking force output element 95b drives the braking force output member 95 as a whole to move towards the interior of the sleeve cavity 930. Because the d2 is not greater than the d1, in this case, the pushing element 2d is about to enter in the sleeve cavity 930 or a space between the plurality of driving force output members 94. In some embodiments, the connecting member 943 is further provided with a positioning protrusion through which the rotational axis L9 extends through. Correspondingly, the pushing element 2d is provided with a positioning hole 2d2 that allows the positioning protrusion to enter. As the braking force output member 95 gradually moves into the sleeve cavity 930, the positioning protrusion 934 begins to enter the positioning hole 2d2, thereby a relative position between the coupling 2 and the force output member 90 can be preliminarily positioned.

However, it can be understood that, even without the aforementioned engagement between the positioning protrusion 934 and positioning hole 2d2, the coupling 2 can also be pre-positioned in the force output member 90 due to the mutual abutment between the pushing surface 2d1 and the second braking force output element 95b, so that it can ensure the smooth engagement between the coupling 2 and force output member 90.

As shown in FIG. 4D and FIG. 5D, when the force output member 90 continues to move/extend in the −x direction, along the rotational axis L9, the braking force output member 95 is disengaged from the intermediate transmission member 96 and becomes freely rotatable in the rotational direction r9 or the direction opposite to the rotational direction r9. That is, the braking force output member 95 can rotate freely in the circumferential direction of the sleeve body 935, and the second elastic pushing member 933 would not suffer elastic deformation. Meanwhile, under an action of an elastic force of the second elastic pushing member 933, the pushing element 2d can also move in the −x direction along the rotational axis L2 by a certain distance. That is, the pushing element 2d retracts towards the interior of the motion cavity 2a1. The driving force receiver 2c enters the sleeve cavity 930 via the exposure opening 931. As shown in FIG. 6, in a direction intersecting with the rotational axes L2/L9, under a pushing action of the first elastic pushing member 932, the driving force output surface 941 overlaps with the driving force receiving surface 2c3. When the force output member 90 begins to rotate, the driving force output surface 941 abuts against the driving force receiving surface 2c3, thereby transmitting the driving force.

It can be seen from the above that, when the coupling 2 in this embodiment is engaged with the force output member 90, the braking force output member 95 in the force output member 90 is shielded, or the braking force output member 95 does not output a braking force to the coupling 2. Correspondingly, the coupling 2 does not need to be provided with a braking force receiver for receiving the braking force, in this way, the configuration of the coupling 2 is simplified, and its manufacturing accuracy requirements of the coupling 2 is reduced. Meanwhile, the braking force output member 95 is pushed and retracted into the sleeve cavity 930 by the pushing element 2d disposed in the coupling 2. The retracting action of the braking force output member 95 is prior to the engagement between the driving force receiver 2c and the driving force output member 94. In other words, before the driving force receiver 2c reaches the position where it can receive the driving force from the driving force output member 94, the pushing element 2d begin to be engaged with/abut against the braking force output member 95. This not only ensures the smooth engagement between the driving force receiver 2c and the driving force output member 94, but also enables a pre-engagement between the coupling 2 and the force output member 90 to be formed to ensure that the relative position of the coupling 2 and the force output member 90 would not change. Correspondingly, a risk of damage to the braking force output member is greatly reduced.

In order to show a positional relation between the driving force output member 94 and the driving force receiver 2c more clearly, the braking force output member 95 is omitted in FIG. 6. Still referring to FIG. 6, a protrusion that may be disposed in the force output member 90 is avoided by the avoiding part 2c2. In some embodiments, a portion of the driving force receiver 2 c reaches below the connecting member 943, that is, the portion of the driving force receiver 2c is deeper into the sleeve cavity 930 than the connecting member 943. As such, the driving force output surface 941 is capable of stably outputting the driving force to the driving force receiving surface 2c3.

As described above, the driving force receiver 2c is further provided with an adjustment surface 2c1. In the process of the coupling 2 being engaged with the force output member 90, along the rotational axis L2/L9, when the driving force receiver 2c does not face the exposure opening 931, but faces the driving force output member 94, the driving force receiver 2c can be guided into the exposure opening 931 by the guide surface 942. The purpose of the driving force receiver 2c entering the exposure opening 931 can be realized through the abutment between the adjustment surface 2c1 and the driving force output member 94.

In an example, the pushing surface 2d1 is configured to be a whole plane extending in the rotational direction r9, such that when the coupling 2 begins to contact the force output member 90, in the rotational direction r9, the pushing surface 2d1 is able to abut against the braking force output member 95, no matter what phase the braking force output member 95 is.

### Embodiment 2

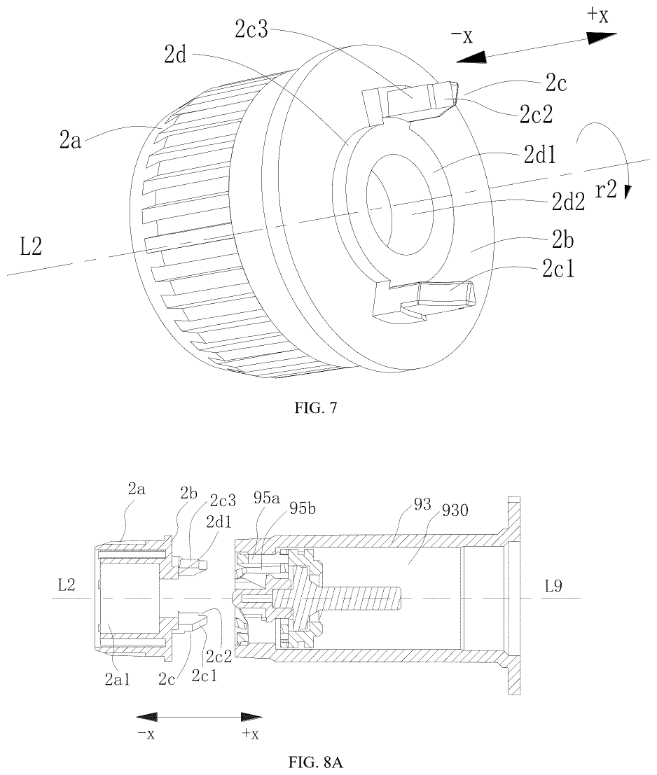

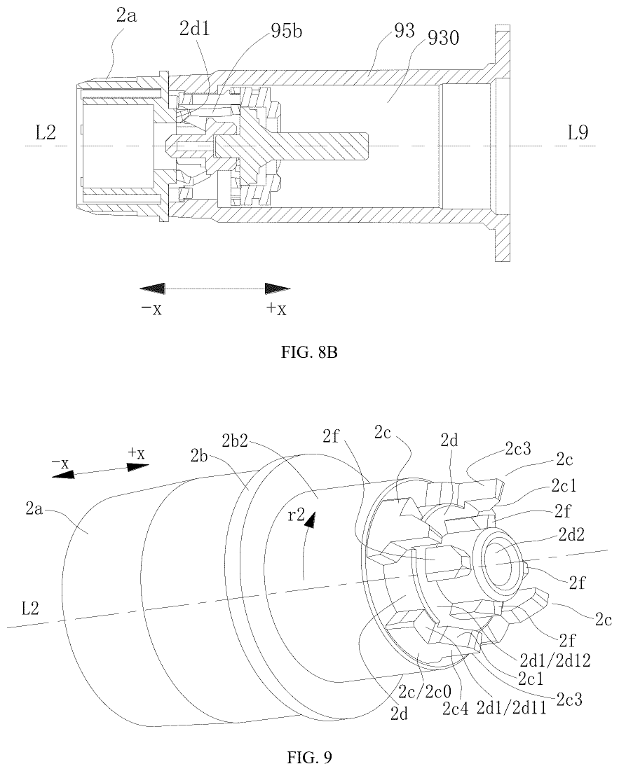

FIG. 7 is a perspective view of a coupling according to Embodiment 2 of the present disclosure. FIG. 8A and FIG. 8b are schematic views showing a process of the coupling being engaged with the force output member according to Embodiment 2 of the present disclosure.

As described above, the pushing element 2d in Embodiment 1 is configured to be retracted or extended relative to the base 2a/base plate 2b along the rotational axis L2, that is, the pushing element 2d is movably disposed in the base 2a. A difference between this embodiment and Embodiment 1 is that the pushing element 2d is fixedly connected to the base 2a/base plate 2b. Along the rotational axis L2, the protruding height of the pushing element 2d relative to the base 2a/base plate 2b, is less than the protruding height of the driving force receiver 2c relative to the base 2a/base plate 2b. In an example, the protruding height of the pushing element 2d is in a range of 1 mm to 2 mm. In other words, along the rotational axis L2, the shortest distance between the pushing surface 2d1 on the pushing element 2d and the base 2a/base plate 2b is in a range of 1 mm to 2 mm. Other structures of the coupling 2 are the same as those of Embodiment 1, which will not be repeatedly described herein.

As shown in FIG. 7, the pushing element 2d is provided as a protrusion from the base 2a/base plate 2b along the rotational axis L2, but the protruding height of the pushing element 2d is less than the protruding height of the driving force receiver 2c. Along the radial direction of coupling 2, the pushing element 2d is located on the inner side of the driving force receiver 2c, that is, the driving force receiver 2c is farther away from the rotational axis L2 than the pushing element 2d. In an example, an end surface of the pushing element 2d forms the pushing surface 2d1.

Referring to FIG. 8A and FIG. 8B, in the process of the coupling 2 being engaged with the force output member 90, when the driving force receiver 2c directly enters the exposure opening 931, in the rotational direction r9, the driving force output surface 941 can directly face the driving force receiving surface 2c3. At the same time, the pushing element 2d forces the braking force output member 95 to retract along the rotational axis L9 towards the interior of the sleeve cavity 930, and the second elastic pushing member 933 is compressed. Under the action of elastic force of the first elastic pushing member 932, in the direction intersecting with the rotational axis L2/L9, the driving force output surface 941 overlaps with the driving force receiving surface 2c3, and the driving force output surface 941 and the driving force receiving surface 2c3 remains stably engaged with each other, and thus the coupling 2 can rotate with the force output member 90 in the rotational direction r9.

In the process of the coupling 2 being engaged with the force output member 90, when the driving force receiver 2c does not directly enter the exposure opening 931, but abuts against the driving force output member 94, under a joint action of the elastic element 2e and the first elastic pushing member 932, with the rotation of the force output member 90, the driving force receiver 2c can be guided by the guide surface 942 or the adjustment surface 2c1 to enter the exposure opening 931. Therefore, the braking force output member 95 is pushed by the pushing element 2d towards the interior of the sleeve cavity 930 and retracted. In the rotational direction r9, the driving force output surface 941 would directly face the driving force receiving surface 2c3. In other words, in the direction intersecting with the rotational axis L9, the driving force output surface 941 and the driving force receiving surface 2c3 overlap with each other and remain stably engaged with each other. The coupling 2 is able to rotate in the rotational direction r9 with the force output member 90.

In the process of the coupling 2 being engaged with the force output member 90, at least a portion of the pushing element 2d can enter the space between the plurality of driving force output members 94. For this reason, in the radial direction of the coupling 2, at least the maximum dimension d2 of the pushing element 2d at the end in the +x direction also does not exceed 11 mm. Specifically, the maximum dimension of the pushing surface 2d1 formed in the pushing element 2d does not exceed 11 mm. When the pushing element 2d is configured as a cylinder, the cross-sectional diameter d2 of the pushing element 2d does not exceed 11 mm.

In the above embodiment, the driving force receiver 2c is able to be either fixedly disposed with respect to the base 2a/base plate 2b or movably disposed with respect to the base 2a/base plate 2b. For example, the driving force receiver 2c and the base 2a/base plate 2b are integrally formed. Alternatively, the driving force receiver 2c is formed separately from the base 2a/base plate 2b, and the driving force receiver 2c can be fixedly connected to the base 2a/base plate 2b by an engagement, bonding, etc. Alternatively, an elastic member is provided between the driving force receiver 2c and the base 2a/base plate 2b. In this case, the driving force receiver 2c is able to move relative to the base 2a/base plate 2b. In an example, the driving force receiver 2c is configured to move relative to the base 2a/base plate 2b along the rotational axis L2. Obviously, the movable driving force receiver 2c relative to the base 2a/base plate 2b is capable of obtaining greater mounting freedom, and having better applicability. In the process of the coupling 2 being engaged with the force output member 90, even if the driving force receiver 2c abuts against the driving force output member 94, the coupling 2 and the force output member 90 can also be smoothly engaged with each other.

As described above, before the coupling 2 is engaged with the force output member 90, along the rotational axis L2, whether the protruding height of the pushing element 2d relative to the base 2a/base plate 2b, is set to be in a range of 1 mm to 7 mm or in a range of 1 mm to 2 mm, it can ensure that the braking force output member 95 is pushed/retracted by the pushing element 2d towards the interior of the sleeve cavity 930 by a certain distance. Such distance can enable the braking force output member 95 to be disengaged from the intermediate transmission member 96. The braking force output member 95 as a whole is able to rotate freely relative to the sleeve body 935. It can be understood that before the coupling 2 is engaged with the force output member 90, the protruding height of the pushing element 2d relative to the base 2a/base plate 2b can be at least 1 mm. Along the rotational axis L2, the pushing surface 2d1 of the pushing element 2d can be configured farther away from the base 2a/base plate 2b than the highest point P of the driving force receiver 2c, or closer to the base 2a/base plate 2b than the highest point P of the driving force receiver 2c. As a variant, along the rotational axis L2, the distance from the pushing surface 2d1 to the base 2a/base plate 2b can also be set to be equal to the distance from the highest point P of the driving force receiver 2c to the base 2a/base plate 2b.

Furthermore, in the process of the coupling 2 being engaged with the force output member 90, along the rotational axis L2/L9, when the driving force output element 2c does not face the exposure opening 931, the pushing element 2d abuts against the braking force output member 95, so that the coupling 2can be pre-positioned. In other words, the pre-engagement between the coupling 2 and the force output member 90 can ensure that the relative position between the coupling 2 and the force output member 90 does not change. As a result, the risk of damage to the brake force output member is greatly reduced. Along the rotational axis L2/L9, when the driving force output 2c faces the exposure opening 931, the pushing element can directly reach the position where it can receive the driving force from the driving force output member. in this case, in the rotational direction r9, the driving force receiving surface 2c3 and the driving force output surface 941 are located on a same circumference, and can abut against or be separated from each other.

### Embodiment 3

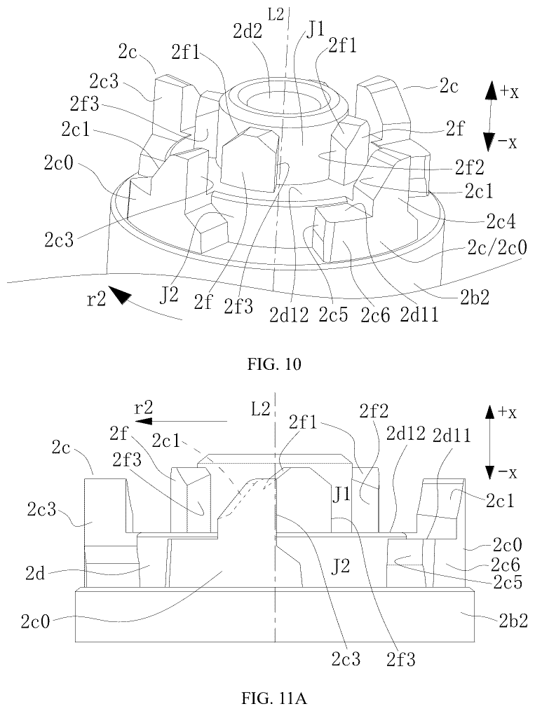

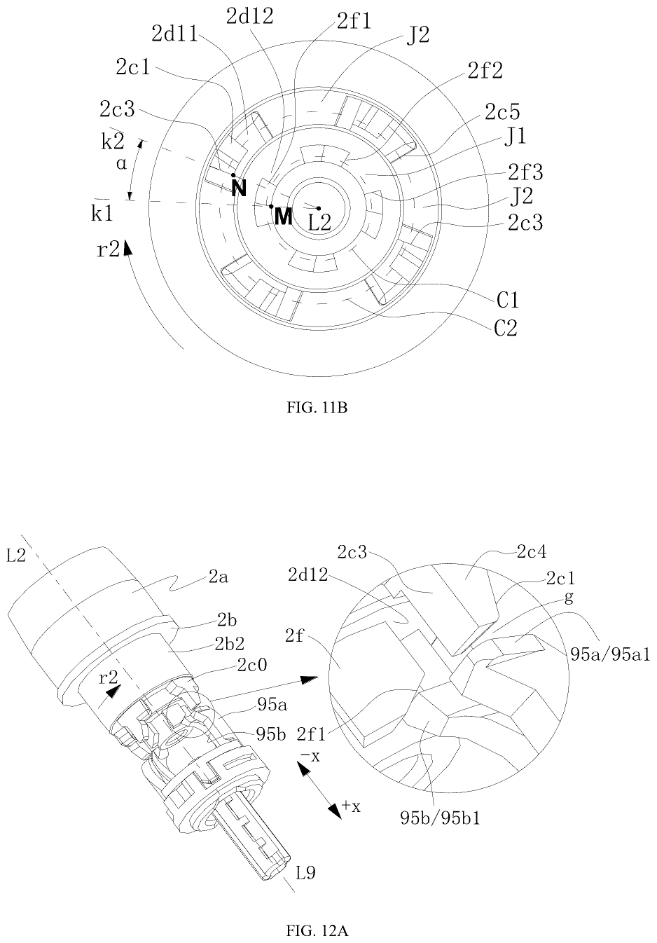

FIG. 9 is a perspective view of a coupling according to Embodiment 3 of the present disclosure. FIG. 10 is a perspective view of the coupling according to Embodiment 3 of the present disclosure with a portion thereof removed. FIG. 11A is a side view observed of the coupling according to Embodiment 3 of the present disclosure, viewed in a direction perpendicular to a rotational axis thereof. FIG. 11B is a side view of the coupling according to Embodiment 3 of the present disclosure, viewed in a direction of the rotational axis thereof.

Based on the abovementioned embodiment, this embodiment modifies the configuration of the coupling 2 so that the coupling 2 and the force output member 90 can be smoothly engaged with each other. As shown in FIG. 9, the coupling 2 still includes the base 2a, the base plate 2b, the driving force receiver 2c, and the pushing element 2d. Similar to the above embodiment, the base plate 2b may be omitted or, alternatively, the base plate 2b and the base plate 2a are integrally formed. Along the rotational axis L2, a boss 2b2 is further provided between the base plate 2b and the pushing element 2d so that the coupling 2 has a wider applicability. In some examples, the boss 2b2 may be omitted, or, the boss 2b2 and the base 2a may be integrally formed.

The following description is given by taking an example in which the boss 2b2 is provided. The pushing element 2d protrudes from the boss 2b2 in a direction away from the base 2a. That is, the pushing element 2d is directly or indirectly connected to the base 2a. A plurality of driving force receivers 2c are spaced apart in the rotational direction r2. In the radial direction of the coupling 2, each of the plurality of driving force receivers 2c is farther away from the rotational axis L2 than at least a portion of the pushing element 2d.

Different from the above embodiment, the coupling 2 according to this embodiment further includes a guiding element 2f. The quantity of the guiding elements 2f corresponds to the quantity of the driving force receivers 2c. In an example, a plurality of guiding elements 2f are provided and spaced apart in the rotational direction r2. In an example, at least two guiding elements 2f and at least two driving force receivers 2c are provided. The two guiding elements 2f are opposed to each other in the radial direction of the coupling 2, the two driving force receivers 2c are opposite to each other in the radial direction of the coupling 2. In an example, at least four guiding elements 2f and at least four driving force receivers 2c are provided. The four guiding elements 2f are distributed in pairwise opposition in the radial direction of the coupling 2, and the four driving force receivers 2c are distributed in pairwise opposition in the radial direction of the coupling 2. In the radial direction of the coupling 2, the guiding element 2f is closer to the rotational axis L2 than the driving force receivers 2c, and the guiding element 2f and the driving force receiver 2c are spaced apart from each other in the radial direction, to reduce the interference during the engagement between the coupling 2 and the force output member 90, and to ensure smooth engagement between the coupling 2 and the force output member 90.

In the process of the coupling 2 being engaged with the force output member 90, the guiding element 2f is configured to guide the braking force output member 95, so that the braking force output member 95 can be pushed/forced by the pushing surface 2d1, to ensure that the driving force output member 94 can be engaged with the driving force receiver 2c smoothly. In other words, smooth opposition or abutment between the driving force output surface 941 and the driving force receiving surface 2c3 in the rotational direction r2 can be ensured.

The coupling 2 is further provided with a positioning hole 2d2 that allows the positioning protrusion 934 to enter. As shown in FIG. 9, the positioning hole 2d2 is disposed on the pushing element 2d. Therefore, the positioning hole 2d2 may also be considered as being disposed in the pushing element 2d. The plurality of guiding elements 2f are arranged in a circumferential direction of the positioning hole 2d2.

Specifically, the guiding element 2f is further provided with a guiding surface 2f1 that is inclined relative to the rotational axis L2. The guiding surface 2f1 can be configured either as an inclined surface or as a spiral surface. When measured along the rotational axis L2, the distance from the guiding surface 2f1 to the surface (the pushing surface 2d1 described hereinbefore or a first pushing surface 2d11 described hereinafter) protruding from the guiding element 2f gradually decreases in the rotational direction r2. In the rotational direction r2, the guiding element 2f further has a first rear end surface 2f3 located upstream of the rotational direction (facing upstream) and a first front end surface 2f2 located downstream of the rotational direction (facing downstream). At least a portion of the first front end surface 2f2 of each guiding element (upstream guiding element) and at least a portion of the first rear end surface 2f3 of the guiding element (downstream guiding element) that is adjacent to this guiding element and located downstream of this guiding element are arranged in the same circumference, and a first clamping space J1 is formed between the at least the portion of the first front end surface 2f2 of this upstream guiding element and the at least the portion of the first rear end surface 2f3 of this downstream guiding element. It can be seen that, the first clamping space J1 is located between two adjacent guiding elements. In an example, the first rear end surface 2f3 and first front end surface 2f2 are located at an upstream end and a downstream end of the guiding element 2f, respectively. As shown in FIG. 11B, when a circle C1 is drawn centered on a point through which the rotational axis L2 passes, the circle C1 extends through both the first front end face 2f2 of the upstream guiding element and the first rear end face 2f3 of the downstream guiding element. In some implementations, the circle C1 also extends through a second pushing surface 2d12 of the pushing surface 2d1, and the guiding element 2f at least partially overlaps with the first pushing surface 2d12 in the rotational direction r2.

The driving force receiver 2c includes a base part 2c0 and a driving force receiving part 2c4 protruding from the base part 2c0. The driving force receiving surface 2c3 is at least arranged on the driving force receiving part 2c4. Along the rotational axis L2, the driving force receiving part 2c4 protrudes from the base part 2c0 in a direction (+x direction) away from the base 2a. Similarly, the driving force receiver 2c is also provided with the adjustment surface 2c1. In the radial direction of the coupling 2, the adjustment surface 2c1 is located outside the guiding surface 2f1.

In the process of coupling 2 being engaged with the force output member 90, the guiding surface 2f1 is configured to guide the second braking force output element 95b/second braking force output part 95b1. In addition to abut against the driving force output member 94 to enable the driving force receiver 2c to enter the exposure opening 931, the adjustment surface 2c1 of this embodiment is also configured to guide the first braking force output element 95a/first braking force output part 95a1, which also enables the driving force receiver 2c to enter the exposure opening 931. Eventually, in the rotational direction r2, the driving force receiver 2c is able to be engaged with the driving force output member 94. In other words, in the rotational direction r2, the driving force receiving surface 2c3 and the driving force output surface 941 are opposed to each other or abut against each other. Therefore, the guiding surface 2f1 and adjustment surface 2c1 have at least a part of the same function. The guiding surface 2f1 may also be referred to as a second adjusting surface, and the adjustment surface 2c1 may be referred to as a first adjusting surface, alternatively, the guiding surface 2f1 is referred to as a second guiding surface, and the adjustment surface 2c1 may also be referred to as the first guiding surface.

As described above, the adjusting surface 2c1 is also configured to be an inclined surface or a spiral surface with respect to the rotational axis L2. Specifically, an inclined direction or a spiral direction of the adjustment surface 2c1 may be described as that, when measured along the rotational axis L2, the distance from the adjustment surface 2c1 to the surface (the pushing surface 2d1 described hereinafter or the second pushing surface 2d12 described hereinbelow) protruding from the driving force receiving part 2c4 is gradually reduced in the rotational direction r2.

(Configuration of the pushing element)

The pushing element 2d is formed as a protrusion protruding from the base part 2c0, and the specific shape of the protrusion is not limited herein, as long as the pushing element 2d is able to play the following pushing/forcing role.

The pushing element 2d has a pushing surface 2d1 facing the +x direction. The pushing surface 2d1 is configured to push the braking force output member 95, enabling the braking force output member 95 to rotate relative to the driving force output member 94/sleeve 93. As such, in the rotational direction r2, the driving force output member 94 is opposed to or abuts against the driving force receiver 2c.

According to the configuration of the braking force output member 95, the pushing surface 2d1 includes the first pushing surface 2d11 and the second pushing surface 2d12 that are distributed in the radial direction of the coupling. The first pushing surface 2d11 is located outside the second pushing surface 2d12, that is, the first pushing surface 2d11 is farther away from the rotational axis L2 than the second pushing surface 2d12. When viewed in the direction perpendicular to the rotational axis of the coupling 2, the first pushing surface 2d11 and the second pushing surface 2d12 may be arranged staggered from each other or flush with each other. The first pushing surface 2d11 is configured to abut against the first braking force output element 95a, and the second pushing surface 2d12 is configured to abut against the second braking force output element 95b. As described above, when any one of the first braking force output element 95a and the second braking force output element 95b receives a force in the +x direction, the braking force output member 95 as a whole can move in the +x direction along the rotational axis L9, that is, the braking force output member 95 as a whole moves towards the interior of the sleeve cavity 930. As such, it is sufficient to provide at least one of the first pushing surface 2d11 and the second pushing surface 2d12. In other words, the first pushing surface 2d11 and the second pushing surface 2d12 may be formed as one piece.

The driving force receiver 2c may also be disposed on the boss 2b2, so that the driving force receiver 2c is directly or indirectly connected to the base 2a. The base part 2c0 extends from the boss 2b2. A portion of the pushing element 2d configured to form the first pushing surface 2d11 may coincide with the base part 2c0. That is, the first pushing surface 2d11 may be arranged on the base part 2c0, or on a component other than the base part 2c0. Apparently, the first pushing surface 2d11 disposed on the base part 2c0 is more conducive to simplify the structure of the coupling 2. When the first pushing surface 2d11 and second pushing surface 2d12 are formed as one piece, the structure of the coupling 2 may be further simplified. In this case, the driving force receiver 2c is farther away from the rotational axis L2 than a portion of the pushing element 2d. As such, the relation between the driving force receiver 2c and the pushing element 2d may be summarized as: in the radial direction of the coupling, the driving force receiver 2c is farther away from the rotational axis of the coupling than at least a portion of the pushing element 2d. As described in Embodiment 1, such configuration can not only avoid the driving force receiver 2c from interfering with the abutment between the pushing element 2d and the braking force output member 95, but also enable the pushing element 2d to be protected by the driving force receiver 2c.

In this embodiment, the guiding element 2f extends from the pushing element 2d along the rotational axis L2 in the direction away from the base 2a. In the radial direction of the coupling 2, the driving force receiver 2c is located outside the guiding element 2f, that is, the driving force receiver 2c is farther away from the rotational axis L2 of the coupling 2 than the guiding element 2f. In the radial direction of the coupling 2, the driving force receiver 2c and the guiding element 2f are spaced apart from each other. In this way, not only the structure of the coupling 2 becomes simple, but also the interference between the process of engaging the driving force receiver 2c with the force output member 90 and the process of engaging the guiding element 2f with the force output member 90 can be reduced or eliminated in the process of engaging the coupling 2 with the force output member 90. For each pair of the driving force receiver 2c and the guiding element 2f, at least a portion of the guiding element 2f/guiding surface 2f1 is always located upstream of the driving force receiver 2c/driving force receiving surface 2c3, in the rotational direction r2. As shown in FIG. 11B, with a point through which the rotational axis L2 extends as the circle center, a first connecting line k1 is formed by connecting the circle center and the most upstream point M of the guiding surface 2f1, a second connecting line k2 is formed by connecting the circle center and the most upstream point N of the driving force receiving surface 2c3. The first connecting line k1 is located upstream of the second connecting line k2. An included angle α formed between the first connecting line k1 and the second connecting line k2 may be in a range of 0° to 10°. It can be understood that, the first connecting line k1 may also be a line connecting the circle center and the most upstream of the guiding surface 2f1, and the second connecting line k2 may also be a line connecting the circle center and the most upstream of the guiding surface 2c3.

As shown in FIG. 11A, when viewed in a direction perpendicular to the rotational axis L2, at least a portion of the guiding surface 2f1 is higher than the adjustment surface 2c1. In other words, at least a portion of the guiding surface 2f1 is farther away from the boss 2b2/base 2a/rotatable body than the adjustment surface 2c1. In this way, the guiding surface 2f1 can contact the braking force output member 95 earlier than the adjustment surface 2c1. Specifically, the moment when the guiding surface 2f1 contacts the second braking force output element 95b is earlier than the moment when the adjustment surface 2c1 contacts the first braking force output element 95a. Such configuration is conducive to prevent the braking force output member 95 and the driving force receiver 2c from abutting against each other in the direction of the rotational axis L2, or to prevent the first braking force output element 95a and the driving force receiving surface 2c3 from interfering with each other.

Furthermore, when viewed in the direction perpendicular to the rotational axis L2, at least a portion of the guiding surface 2f1 is higher than the pushing surface 2d1. In other words, at least a portion of the guiding surface 2 f is farther away from the boss 2b2/base 2a/rotatable body than the pushing surface 2d1, which enables the guiding surface 2f1 to contact the braking force output member 95 earlier than the pushing surface 2d1. In other examples of the present disclosure, the guiding element 2f may also extend from the boss 2b2 along the rotational axis L2 in the direction away from the base 2a. In the rotational direction r2, a gap may further be formed between the guiding element 2f and the pushing element 2d, as long as the braking force output member 95 can be guided by the guiding surface 2f1 to the pushing surface 2d1 (the second pushing surface 2d12). Similarly, in the rotational direction r2, a gap may also be formed between the pushing element 2d and the driving force receiver 2c, as long as the braking force output member 95 can be guided by the adjustment surface 2c1 to the pushing surface 2d1 (the first pushing surface 2d11). As such, a protruding block 2c6 that forms the first pushing surface 2d11 and the base part 2c0 of the driving force receiver can be integrally formed, or spaced apart from each other.

When the protruding block 2c6 and the base part 2c0 are integrally formed, the structure of the coupling 2can be simplified. The following description is given by taking an example in which the protruding block 2c6 and the base part 2c0 are integrally formed. It can be understood that, even if a gap is formed between the protruding block 2c6 and the base part 2c0, the protruding block 2c6 and the base part 2c0 are considered as a whole in the present disclosure.

In the rotational direction r2, the driving force receiver 2c has a second front end surface 2c5 located downstream of the rotational direction (facing downstream) and a second rear end surface located upstream of the rotational direction (facing upstream). At least a portion of the second front end surface 2c5 of each driving force receiver (upstream driving force receiver) and at least a portion of the second rear end surface on a guiding element (downstream driving force receiver) that is adjacent to the driving force receiver and located downstream of the driving force receiver are arranged in the same circumference, and a second clamping space J2 is formed between the at least the portion of the second front end surface 2c5 of the upstream driving force receiver and the at least the portion of the second rear end surface on the downstream driving force receiver. It can be seen that, the second clamping space J2 is located between two adjacent driving force receivers. In an example, the second front end surface 2c5 and the second rear end surface are located at an upstream end and a downstream end of the driving force receiver 2c, respectively. According to a structural design of the driving force receiver 2c, there may be multiple options for the second rear end surface. In an example, the second rear end surface is the driving force receiving surface 2c3. As shown in FIG. 11B, when a circle C2 is drawn with a point through which the rotational axis L2 extends as the circle center, the circle C2 may extend through the second front end surface 2c5 of the upstream driving force receiver and the second rear end surface 2c3 of the downstream driving force receiver. In some implementations, the circle C2 also extends through the first pushing surface 2d11. The driving force receiver 2c at least partially overlaps with the first pushing surface 2d11 in the rotational direction r2.

When viewed in the direction perpendicular to the rotational axis L2, the driving force receiver 2c/driving force receiving surface 2c3/adjustment surface 2c1 is farther away from the boss 2b2/base 2a/rotatable body than the pushing element 2d/pushing surface 2d1. This enables the pushing surface 2d1 to abut more closely against the braking force output member 95. In other words, the braking force output member 95 is more stably pushed to a predetermined position by the pushing surface 2d1.

### Process of Engaging the Coupling With Force Output Member

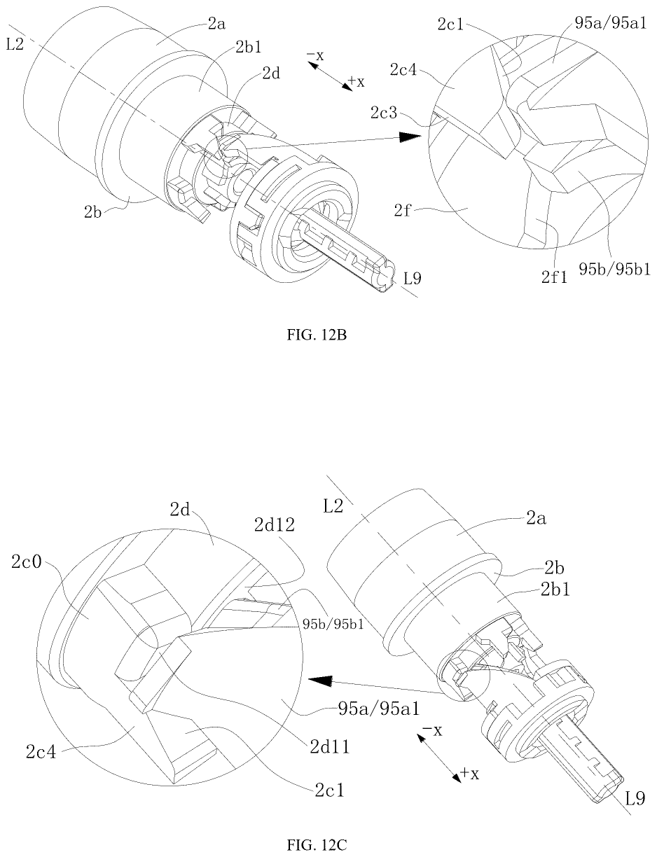

FIG. 12A to FIG. 12care schematic views of a process of the coupling being engaged with the force output member according to Embodiment 3 of the present disclosure.

As described above, after the process cartridge 100 reaches the predetermined mounting position of the imaging device, with the cover is closed, the force output member 90 begins to extend along the rotational axis L9 in the −x direction. As shown in FIG. 12A, as the coupling 2 begins to abut against the force output member 90, the guiding surface 2f1 abuts against the second braking force output element 95b/second braking force output part 95b1. The driving force receiver 2c does not abut against the first braking force output element 95a/first braking force output part 95a1. In this case, along the rotational axis L2, a gap g is formed between the driving force receiver 2c and the first braking force output element 95a/first braking force output part 95a1. As the force output member 90 continues to extend out, the guiding surface 2f1 abuts against the second braking output element 95b/second braking output part 95b1, so that the braking force output member 95 as a whole is pushed in the rotational direction r2/r9 and gradually moves away from the driving force output member 94. As shown in FIG. 12B, as the second braking force output element 95b/second braking force output part 95b1 continues to be guided by the guiding surface 2f1, the first braking force output element 95a/first braking force output part 95a1 begins to abut against the adjustment surface 2c1. Eventually, the first braking force output element 95a and the second braking force output element 95b reach the positions shown in FIG. 12crespectively. In this case, the first pushing surface 2d11 abuts against the first braking force output element 95a/first braking force output part 95a1, and/or, the second pushing surface 2d12 abuts against the second braking force output element 95b/second braking force output part 95b1. That is, it is sufficient to realize at least one of the abutment between the first pushing surface 2d11 and the first braking force output element 95a/first braking force output part 95a1 and the abutment between the second pushing surface 2d12 and the second braking force output element 95b/second braking force output part 95b1. The braking force output member 95 as a whole retracts towards the interior of the sleeve cavity 930. In the rotational direction r9, the braking force output member 95 and the driving force output member 94/sleeve 93 are rotatable relative to each other. The driving force output member 94 is opposed to or abut against the driving force receiver 2c. In other words, the driving force output surface 941 is opposed to or abut against the driving force receiving surface 2c3.

Further, in a state shown in FIG. 12c, the second braking force output element 95b enters the first clamping space J1. In this case, in the rotational direction r2, the first front end surface 2f2 and the first rear end surface 2f3 simultaneously abut against the first braking force output element 95b, and the driving force output member 94 enters the second clamping space J2. In this case, in the rotational direction r2, the second front end surface 2c5 and the second rear end surface 2c3 simultaneously abut against the driving force output member 94. In this way, the second braking force output element 95b is positioned, and the first braking force output element 95a is positioned simultaneously with the second braking force output element 95b, and the driving force output member 94 is also positioned. As such, the possible shaking of the entire force output member 90 is suppressed, and the coupling 2 and the force output member 90 can be stably engaged with each other. In the present disclosure, four guiding elements 2f and four driving force receivers 2c may be provided, so that when the coupling 2 begins to be engaged with the force output member 90, the coupling 2 and the force output member 90 are able to be engaged with each other smoothly regardless of the phase of the coupling 2.

On the contrary, two guiding elements 2f may be provided, and two driving force receivers 2c may also be provided, without considering that the second braking force output element 95b is positioned and the driving force output member 94 is also positioned.

It is to be noted that, the moment when the first pushing surface 2d11 contacts the first braking force output element 95a, and/or, the moment when the second pushing surface 2d12 contacts the second braking force output element 95b, and the moment when the engagement between the coupling 2 and the force output member 90 is completed do not have to be corresponded to each other. The moment when the engagement between the coupling 2 and the force output member 90 is completed, may refer to the case where the driving force output surface 941 and the driving force receiving surface 2c3 are opposed to each other in the rotational direction r9, or the case where the driving force output surface 941 abuts against the driving force receiving surface 2c3. However, after the engagement between the coupling 2 and force output member 90 is completed, the first pushing surface 2d11 remains in an abutment against the first braking force output element 95a, and/or, the second pushing surface 2d12 remains in an abutment against the second braking force output element 95b. In addition, along the rotational axis L9 of the force output member 90, the braking force output member 95 and the driving force output member 94 are disengaged from each other. in this way, in the rotational direction r9, the braking force output member 95 is not able to be driven by the driving force output member 94.

As described above, after the coupling 2 according to this embodiment is engaged with the force output member 90, the braking force output member 95 in the force output member 90 does not output the braking force to the coupling 2. The structure of the coupling 2can be simplified, and the manufacturing accuracy requirements thereof may be reduced. In addition, in the process of the coupling 2 being engaged with the force output member 90, the risk of the damage to the braking force output member is also greatly reduced.

The coupling according to the present disclosure can decrease the manufacturing accuracy requirements of the coupling and preventing a braking force output member of a force output member from being damaged during a process of engaging the coupling with the force output member.

The present disclosure provides a coupling, configured to receive a driving force from a force output member disposed in an imaging device to drive a rotatable body to rotate. The force output member includes a braking force output member and a driving force output member that are arranged coaxially. The coupling includes a driving force receiver and a pushing element. The driving force receiver is configured to be engaged with the driving force output member to receive the driving force to drive the rotatable body to rotate. The pushing element is configured to abut against the braking force output member. When viewed in a direction perpendicular to a rotational axis of the coupling, the driving force receiver is farther away from the rotatable body than the pushing element. The coupling does not need to be provided with a component for receiving a braking force, the structure of the coupling is thus able to be simplified and the manufacturing accuracy requirements thereof are reduced, and a risk of damage to the braking force output member in the force output member is reduced.

In some embodiments of the present disclosure in a radial direction of the coupling, the driving force receiver is disposed farther away from the rotational axis of the coupling than at least a portion of the pushing element.

In some embodiments of the present disclosure, the coupling further includes a base configured to transmit the driving force received by the driving force receiver, to drive the rotatable body to rotate. The driving force receiver is indirectly or directly movably disposed on the base.

In some embodiments of the present disclosure, the pushing element has a pushing surface configured to push the braking force output member. The coupling further includes a guiding element. During a process of the coupling being engaged with the force output member, the guiding element guides the braking force output member towards the pushing surface.

In some embodiments of the present disclosure, in a radial direction of the coupling, the guiding element and the driving force receiver are spaced apart from each other.

In some embodiments of the present disclosure, in a radial direction of the coupling, the driving force receiver is farther away from the rotational axis of the coupling than the guiding element.

In some embodiments of the present disclosure, in a rotational direction of the coupling, the driving force receiver at least partially overlaps with the pushing element.

In some embodiments of the present disclosure, the pushing element includes a first pushing surface and a second pushing surface that are arranged in a radial direction of the coupling. The first pushing surface is located outside the second pushing surface. In a rotational direction of the coupling, the first pushing surface at least partially overlaps with the driving force receiver, and the second pushing surface at least partially overlaps with the guiding element.

In some embodiments of the present disclosure, the guiding element is provided with a second guiding surface configured to guide the braking force output member. The driving force receiver is provided with a first guiding surface configured to guide the braking force output member. When viewed in a direction perpendicular to the rotational axis of the coupling, at least a portion of the second guiding surface is farther away from the rotatable body than the first guiding surface.

In some embodiments of the present disclosure, when viewed in the direction perpendicular to the rotational axis of the coupling, at least a portion of the second guiding surface is farther away from the rotatable body than the pushing surface.

The guiding element is provided with a second guiding surface configured to guide the braking force output member. The driving force receiver has a driving force receiving surface configured to receive the driving force. When viewed along the rotational axis of the coupling, an included angle formed between a line connecting a most upstream point or line of the second guiding surface and a circle center, and a line connecting a most upstream point or line of the driving force receiver and the circle center is in a range of 0° to 10°.

In some embodiments of the present disclosure, the driving force receiver has a driving force receiving surface configured to receive the driving force. In a rotational direction of the coupling, at least a portion of the guiding element is located upstream of the driving force receiving surface.

In some embodiments of the present disclosure, in the coupling, a plurality of guiding elements are spaced apart from each other in a rotational direction of the coupling, and a plurality of driving force receivers are spaced apart from each other in the rotational direction of the coupling. A first clamping space is formed between two adjacent guiding elements. A second clamping space is formed between two adjacent driving force receivers. The first clamping space is configured to allow the braking force output member to enter, and the second clamping space is configured to allow the driving force output member to enter. In an example, four guiding elements and four driving force receivers are provided.

The present disclosure further provides a rotatable member including a rotatable body and the aforementioned coupling. The coupling and the rotatable body are arranged coaxially.

The present disclosure further provides a process cartridge including a housing and the rotatable member. The rotatable member rotatably disposed in the housing.

The present disclosure further provides another process cartridge, which includes a housing, a rotatable body rotatably mounted in the housing, the coupling as described above, and a driving force transmission device provided between the coupling and the rotatable body. The coupling and the rotatable body are not coaxial. A driving force from the coupling is transmitted to the rotatable body through the driving force transmission device.

1. A coupling, configured to receive a driving force from a force output member disposed in an imaging device to drive a rotatable body to rotate, the force output member comprising a braking force output member and a driving force output member that are arranged coaxially, the coupling comprising a driving force receiver and a pushing element;
wherein the driving force receiver is configured to be engaged with the driving force output member to receive the driving force to drive the rotatable body to rotate; and
the pushing element is configured to abut against the braking force output member;
wherein when viewed in a direction perpendicular to a rotational axis of the coupling, the driving force receiver is farther away from the rotatable body than the pushing element.

2. The coupling according to claim 1, wherein in a radial direction of the coupling, the driving force receiver is disposed farther away from the rotational axis of the coupling than at least a portion of the pushing element.

3. The coupling according to claim 1, wherein the coupling further comprises a base configured to transmit the driving force received by the driving force receiver, to drive the rotatable body to rotate; wherein the driving force receiver is indirectly or directly movably disposed on the base.

4. The coupling according to claim 1, wherein the pushing element has a pushing surface configured to push the braking force output member; the coupling further comprises a guiding element, wherein the guiding element guides the braking force output member towards the pushing surface during a process of the coupling being engaged with the force output member.

5. The coupling according to claim 4, wherein in a radial direction of the coupling, the guiding element and the driving force receiver are spaced apart from each other.

6. The coupling according to claim 4, wherein in a radial direction of the coupling, the driving force receiver is farther away from the rotational axis of the coupling than the guiding element.

7. The coupling according to claim 4, wherein in a rotational direction of the coupling, the driving force receiver at least partially overlaps with the pushing element.

8. The coupling according to claim 4, wherein the pushing element comprises a first pushing surface and a second pushing surface that are arranged in a radial direction of the coupling, wherein the first pushing surface is located outside the second pushing surface, wherein in a rotational direction of the coupling, the first pushing surface at least partially overlaps with the driving force receiver, and the second pushing surface at least partially overlaps with the guiding element.

9. The coupling according to claim 4, wherein the guiding element is provided with a second guiding surface configured to guide the braking force output member; and the driving force receiver is provided with a first guiding surface configured to guide the braking force output member, wherein when viewed in a direction perpendicular to the rotational axis of the coupling, at least a portion of the second guiding surface is farther away from the rotatable body than the first guiding surface.

10. The coupling according to claim 9, wherein when viewed in the direction perpendicular to the rotational axis of the coupling, at least a portion of the second guiding surface is farther away from the rotatable body than the pushing surface.

11. The coupling according to claim 4, wherein the guiding element is provided with a second guiding surface configured to guide the braking force output member, and the driving force receiver has a driving force receiving surface configured to receive the driving force, wherein when viewed along the rotational axis of the coupling, an included angle formed between a line connecting a most upstream point or line of the second guiding surface and a circle center, and a line connecting a most upstream point or line of the driving force receiver and the circle center is in a range of 0° to 10°.

12. The coupling according to claim 4, wherein the driving force receiver has a driving force receiving surface configured to receive the driving force, wherein in a rotational direction of the coupling, at least a portion of the guiding element is located upstream of the driving force receiving surface.

13. The coupling according to claim 4, wherein a plurality of guiding elements are spaced apart from each other in a rotational direction of the coupling, and a plurality of driving force receivers are spaced apart from each other in the rotational direction of the coupling, wherein a first clamping space is formed between two adjacent guiding elements, and a second clamping space is formed between two adjacent driving force receivers, wherein the first clamping space is configured to allow the braking force output member to enter, and the second clamping space is configured to allow the driving force output member to enter.

14. The coupling according to claim 13, wherein four guiding elements and four driving force receivers are provided.

15. A rotatable member, comprising a rotatable body, and the coupling according to claim 1, wherein the coupling and the rotatable body are arranged coaxially.

16. A process cartridge, comprising:
a housing; and
the rotatable member according to claim 15, wherein the rotatable member is rotatably disposed in the housing.

17. A process cartridge, comprising:
a housing; and
a rotatable body rotatably mounted in the housing;
the coupling according to claim 1; and
a driving force transmission device provided between the coupling and the rotatable body, wherein the coupling and the rotatable body are not coaxial, and a driving force from the coupling is transmitted to the rotatable body through the driving force transmission device.
